(19) United States
(12) Patent Application Publication
(10) Pub. No.: US 2019/0001343 A1
(43) Pub. Date: Jan. 3, 2019

(54) APPARATUS AND METHODS FOR PROCESSING MAGNETIC PARTICLES

(71) Applicant: Siemens Healthcare Diagnostics Inc., Tarrytown, NY (US)

(72) Inventors: Oleg Grebenuk, Sherborn, MA (US); John G. Raymond, Stoneham, MA (US); Gary Boys, Northborough, MA (US)

(73) Assignee: Siemens Healthcare Diagnostics Inc., Tarrytown, NY (US)

(21) Appl. No.: 16/067,592

(22) PCT Filed: Dec. 28, 2016
(86) PCT No.: PCT/US2016/068955

§ 371 Date: Jun. 29, 2018

Related U.S. Application Data
(60) Provisional application No. 62/274,123, filed on Dec. 31, 2015.

(51) Int. Cl. B03C 1/28; B03C 1/005

(52) U.S. Cl. CPC B03C 1/288; B03C 2201/26; B03C 2201/18; B03C 1/005

(57) ABSTRACT

An apparatus for processing magnetic particles comprises a sealed enclosure and a magnetic field source. The sealed enclosure comprises an inlet into the enclosure and an outlet from the enclosure. The configuration of the sealed enclosure and of the inlet and the outlet are such that fluid containing the magnetic particles that is introduced into the enclosure through the inlet exhibits a spiral flow towards the outlet. The magnetic field source is disposed to the enclosure to intermittently apply a magnetic field to the fluid contained therein.

### CROSS-REFERENCE TO RELATED APPLICATIONS

This application claims priority of U.S. Provisional Application No. 62/274,123, filed Dec. 31, 2015, which is incorporated by reference herein in its entirety.

### BACKGROUND

The present invention relates generally to processing magnetic particles. In some embodiments the present invention is directed to apparatus and methods for processing magnetic particles that are useful as assay reagents.

Magnetic particles used for conducting assays on biological samples are normally processed prior to their intended use. The preparation process includes one or more cycles of separating particles from a liquid containing the particles and re-suspending the particles in a fresh liquid. This cycle typically is accomplished by placing a vessel containing liquid with suspended magnetic particles in close proximity to a magnet. The particles are magnetophoretically separated and retained on the wall of the vessel until the magnet is moved away. Then, liquid in the vessel is mechanically agitated to re-suspend the magnetic particles.

Present approaches have certain drawbacks. For example, a vessel containing a liquid that is stagnant might be used for relatively small batches of magnetic particles, e.g., on the order of up to about 5 liters (L). Processing relatively large volumes of liquid (on the order of about 5 L to about 20 L or more containing magnetic particles requires a long time to achieve separation of the magnetic particles. Using magnetic separation on stagnant volumes above 20 L has been impractical due to an enormous size and weight of the magnets necessary for the separation. The use of flow-through separators with retractable magnets and mechanical agitator results in subjecting magnetic particles to high shear from agitator blades. Furthermore, such systems do not have uniform flow and are not disposable because of their complexity and cost.

There is a need for processing magnetic particles that avoids the drawbacks of known processing apparatus and techniques.

### SUMMARY

One example in accordance with the principles described herein is an apparatus for processing magnetic particles. The apparatus comprises a sealed enclosure and a magnetic field source. The sealed enclosure comprises an inlet into the enclosure and an outlet from the enclosure. The configuration of the sealed enclosure and of the inlet and the outlet are such that fluid containing the magnetic particles that is introduced into the enclosure through the inlet exhibits a spiral flow towards the outlet. The magnetic field source is disposed to the enclosure to intermittently apply a magnetic force to the fluid contained therein.

Another example in accordance with the principles described herein is directed to a method for processing magnetic particles. The method comprises introducing a fluid containing the magnetic particles into an inlet of a sealed enclosure comprising an inlet into the enclosure and an outlet from the enclosure. The configuration of the sealed enclosure and of the inlet and the outlet are such that fluid containing the magnetic particles that is introduced into the enclosure through the inlet exhibits a spiral flow towards the outlet. A magnetic field source is intermittently activated to apply a magnetic force to the fluid in the sealed enclosure to adhere the magnetic particles to an inner wall of the sealed enclosure.

Another example in accordance with the principles described herein is directed to a method for processing magnetic particles. The method comprises subjecting a fluid containing the magnetic particles to a spiral fluid flow and intermittently applying a magnetic force to the fluid to retain the magnetic particles while allowing fluid to flow away from the retained magnetic particles.

### BRIEF DESCRIPTION OF DRAWINGS

The drawings provided herein are not to scale and are provided for the purpose of facilitating the understanding of certain examples in accordance with the principles described herein and are provided by way of illustration and not limitation on the scope of the appended claims.

FIG. 1 is a schematic diagram of an example of an apparatus in accordance with the principles described herein.

FIG. 2 is a schematic diagram of another example of an apparatus in accordance with the principles described herein.

FIG. 3 is a schematic diagram of another example of an apparatus in accordance with the principles described herein.

FIG. 4 is a schematic diagram of another example of an apparatus in accordance with the principles described herein comprising an array of multiple apparatus of FIG. 1 fluidically associated with one another.

FIG. 5 is a schematic diagram of another example of an apparatus in accordance with the principles described herein comprising an array of two apparatus of FIG. 1, where the apparatus differ in size and are fluidically associated with one another.

FIG. 6 is a schematic diagram depicting a tangential angle as applied to an inlet and an outlet of apparatus in accordance with the principles described herein.

### DETAILED DESCRIPTION OF SPECIFIC EMBODIMENTS

The present applicant has discovered that drawbacks in known methods for processing magnetic particles are avoided by subjecting a fluid containing the magnetic particles to a spiral flow and intermittently applying a magnetic field or a magnetic force to the fluid to retain the magnetic particles while allowing fluid to flow away from the retained magnetic particles. The use of spiral flow of the fluid containing magnetic particles facilitates re-suspension of the magnetic particles in, for example, a wash fluid, when a magnetic field or magnetic force is not applied to the fluid. Examples of apparatus and methods in accordance with the principles described herein are automatable and scalable. Such apparatus and methods have particular application to processing large volumes of fluid containing magnetic particles. In some examples, the apparatus in accordance with the principles described herein are fabricated from inexpensive materials and are disposable often after a single use. Magnetic particles are retained in apparatus in accordance with the principles described herein depending on the magnitude of the magnetic field or magnetic force applied to the magnetic particles, the travel distance of the fluid in the apparatus, and residence time of the fluid in the apparatus. Magnetic particles are retained in the apparatus when the strength of the magnetic field is sufficiently strong and the shear force from moving fluid is concomitantly weak. Numerous conditions are possible using apparatus and methods in accordance with the principles described herein that allow retaining magnetic particles while fluid flows past the retained magnetic particles.

Examples of methods and apparatus in accordance with the principles described herein have application to the magnetic particles of any kind where the processing of such particles involves separating particles from a fluid and then re-suspending the magnetic particles in a fluid, which may be the same fluid or a different fluid from which the magnetic particles are separated. In some examples, the magnetic particles are those that are useful in biological systems involving separations. In these examples, the magnetic particles are coupled to biological or organic molecules with affinity for or the ability to adsorb or which interact with certain other biological or organic molecules. Such magnetic particles may be used for both diagnostic and therapeutic applications involving separation steps or the directed movement of coupled molecules to particular sites. Diagnostic uses include, but are not limited to, biological assays such as, binding assays, e.g., immunoassays; biochemical or enzymatic reactions; affinity chromatographic purifications; and cell sorting, for example. Therapeutic applications include monoclonal antibody therapy, for example.

In some examples, the diagnostic systems are immunoassays, which may involve labeled and/or non-labeled reagents. Immunoassays involving non-labeled reagents usually comprise the formation of relatively large complexes involving one or more antibodies. The assays may be heterogeneous (involving a separation step) or homogeneous (not involving a separation step), competitive or non-competitive. The assay may be described as “competitive” if the amount of bound measurable label is generally inversely proportional to the amount of analyte originally in solution or “non-competitive” if the amount of bound measurable label is generally directly proportional to the amount of analyte originally in solution. Such assays include, for example, immunoprecipitin and agglutination methods and corresponding light scattering techniques such as, e.g., nephelometry and turbidimetry, for the detection of antibody complexes. Labeled immunoassays include, but are not limited to, chemiluminescence immunoassays, enzyme immunoassays, fluoroimmunoassays, fluorescence polarization immunoassays, radioimmunoassay, inhibition immunoassays, induced luminescence assays, immunoradiometric assays, sandwich immunoassays and fluorescent oxygen channeling assays, for example.

Magnetic particles that are used as an assay reagent may be coupled to an sbp member, which is one of two different molecules, having an area on the surface or in a cavity, which specifically binds to and is thereby defined as complementary with a particular spatial and polar organization of the other molecule. The sbp members will usually be members of an immunological pair such as antigen-antibody or hapten-antibody although other specific binding pairs such as biotin-avidin, hormones-hormone receptors, enzyme-substrate, nucleic acid duplexes, IgG-protein A, polynucleotide pairs such as DNA-DNA, DNA-RNA, for example, are not immunological pairs but are included within the scope of the phrase sbp member. Other assay reagents are normally used in such assays, which may include, for example, other sbp members and members of a signal producing system (“sps member”).

As used herein, the phrase “coupled to” includes covalent binding of one moiety to another moiety either by a direct bond or through a spacer group, non-covalent binding of one moiety to another moiety either directly or by means of specific binding pair members bound to the moieties, and coating one moiety on another moiety, for example.

In addition to their use in the solid phase biological assays just described, magnetic particles may be used for a variety of other biological purposes. Magnetic particles may be used in cell sorting systems to isolate select viruses, bacteria and other cells from mixed populations. Another use of magnetic particles is in affinity chromatography systems to selectively isolate and purify molecules from solution. Magnetic particles are particularly advantageous for purifications from colloidal suspensions. Magnetic particles may be used as the solid phase support in immobilized enzyme systems. Enzymes coupled to magnetic particles are contacted with substrates for a time sufficient to catalyze the biochemical reaction. Thereafter, the enzyme can be magnetically separated from products and unreacted substrate and potentially can be reused.

In some examples, the magnetic particles are paramagnetic. The term “paramagnetic” refers to substances in which slight magnetic properties may be introduced resulting in a weak attraction to either pole of a magnet, a state that is lost upon removal from the magnetic field. Paramagnetic substances typically have unpaired “d” electrons. Paramagnetic substances include, but are not limited to, metal salts such as metal oxides, and metal halides, for example; and metallic elements, for example. The metal may be, by way of illustration and not limitation, iron, chromium, lithium, sodium, magnesium, aluminum, manganese, strontium, zirconium, molybdenum, ruthenium, rhodium, palladium, tin, samarium, europium, tungsten, and platinum, for example, or mixtures of two or more of the above.

For diagnostic and therapeutic purposes, the magnetic particles generally have an average diameter of about 0.02 to about 100 microns, or about 0.05 to about 100 microns, or about 0.1 to about 100 microns, or about 0.5 to about 100 microns, or about 0.02 to about 50 microns, or about 0.05 to about 50 microns, or about 0.1 to about 50 microns, or about 0.5 to about 50 microns, or about 0.02 to about 20 microns, or about 0.05 to about 20 microns, or about 0.1 to about 20 microns, or about 0.5 to about 20 microns, for example. In some embodiments, the particles have an average diameter from about 0.05 microns to about 20 microns or from about 0.3 microns to about 10 microns, or about 0.3 microns to about 5 microns, for example.

As mentioned above, the magnetic particles are present in a fluid for processing. In many examples, the fluid is an aqueous medium, which may be an aqueous buffered medium at a moderate pH. The aqueous medium may be solely water or may include from 0.1 to about 40 volume percent of a cosolvent such as, for example, a water miscible organic solvent, e.g., an alcohol, an ether or an amide. The pH for the medium will usually be in the range of about 4 to about 11, or in the range of about 5 to about 10, or in the range of about 6.5 to about 9.5, for example. Various buffers may be used to achieve the desired pH and maintain the pH during processing. Illustrative buffers include borate, phosphate, carbonate, tris, barbital, PIPES, HEPES, MES, ACES, MOPS, BICINE, and the like.

As mentioned above, an example in accordance with the principles described herein is an apparatus for processing magnetic particles that comprises a sealed enclosure and a magnetic field source. The sealed enclosure comprises an inlet into the enclosure and an outlet from the enclosure. The configuration of the sealed enclosure and of the inlet and the outlet are such that fluid containing the magnetic particles that is introduced into the enclosure through the inlet at a sufficient flow rate exhibits a spiral flow towards the outlet. The magnetic field source is disposed to the enclosure to intermittently apply a magnetic field to the fluid contained therein.

As indicated above, fluid is introduced into the enclosure through the inlet at a flow rate that, in conjunction with a configuration or a structural design of the enclosure and of the inlet and the outlet, is sufficient to achieve spiral flow of fluid through the enclosure. The flow rate that is sufficient to achieve spiral flow is dependent on one or more of the nature of the fluid, the amount of the fluid, nature of the enclosure, the nature of the inlet and the outlet, a size of the enclosure, an inner diameter of the inlet and the outlet, an inner diameter of the enclosure, and the axial direction of the inlet and outlet, for example. In one approach the flow rate sufficient to achieve spiral flow within the enclosure may be determined empirically.

An enclosure in accordance with the principles described herein may be fabricated from any material suitable for the intended use of the enclosure for processing magnetic particles. An enclosure in accordance with the principles described herein may be fabricated from a material that provides one or more of mechanical strength, chemical stability and non-magnetic properties. In some examples, an enclosure may be fabricated from reusable material such as stainless steel or some other suitable metal, for example, or a combination of two or more thereof. In some examples, an enclosure in accordance with the principles described herein is fabricated from inexpensive materials, which may be polymeric, and the enclosure is disposable often after a single use. Suitable materials for an enclosure in accordance with the principles described herein include, but are not limited to, poly (vinyl chloride), polyacrylamide, polyacrylate, polyethylene, polypropylene, poly(4-methylbutene), polystyrene, polymethacrylate, poly(ethylene terephthalate), nylon, polyvinylidene fluoride, polytetrafluoroethylene, perfluoroalkoxy polymer, fluorinated ethylene-propylene, and poly(vinyl butyrate), for example, either used by themselves or in conjunction with other materials.

An interior of an enclosure in accordance with the principles described herein may have internal structural features that improve rigidity and mechanical strength of the enclosure permitting the walls of the enclosure to be thinner. The internal structural features can also direct flow of fluid through the enclosure and inhibit mixing with the enclosure. The size, shape, placement, and number of the structural features may be chosen to achieve one or more of the benefits mentioned above. In some examples, the structural features may be ribs rising on the inner surface or ribs connecting opposite inner surfaces, for example.

An apparatus in accordance with the principles described herein further comprises a fluid flow initiator fluidically associated with the enclosure. The fluid flow initiator is any device that can produce a force sufficient to achieve spiral flow in the enclosure. The nature of the fluid flow initiator is dependent on one or more of the nature of the fluid, the nature of the enclosure, and the size of the enclosure, for example. In some examples, the fluid flow initiator is, but is not limited to, a pump, a suction device, gravity, or a compressed gas source connected to the vessel with treated liquid, for example. The phrase “fluidically associated with” means that the fluid flow initiator is associated with an inlet and/or outlet of the enclosure by a connector such as, but not limited, piping and tubing, for example.

An apparatus in accordance with the principles described herein further includes one or more magnetic field sources disposed to the enclosure to intermittently apply a magnetic force or magnetic field to the fluid that is flowing through the enclosure. The strength of the magnetic force imposed on the particles by the magnetic field source is dependent on one or more or the nature of the magnetic particles including but not limited to the size of the magnetic particles, the nature of the magnetic field source, a presence of an adjacent magnetic field source, the nature of the materials employed in the construction of the enclosure, the nature of the fluid, and the distance, for example. In some examples, the strength of the magnetic force is about 0.1 Tesla to about 10 Tesla. The number of magnetic field sources is dependent on one or more of nature of the magnetic particles, the nature of the magnetic field source, the nature of the enclosure, the nature of the fluid, and the number of enclosures in the apparatus, for example.

The magnetic field source may be selected from, by way of illustration and not limitation, permanent magnets and electromagnets, for example. For a permanent magnet, the size and shape is dependent on one of more of the considerations set forth above and consideration for magnetic field gradient responsible for the unidirectional movement of the magnetic particles. The manner in which the magnetic field source is disposed to the enclosure to intermittently apply a magnetic field to the fluid that is flowing through the enclosure is dependent on one or more of the considerations mentioned above for the strength of the magnetic field. One or both of the magnetic field source and the enclosure may be movable with respect to the other. One or both of the magnetic field source and the enclosure may be mounted on a support such as, for example, an arm or a plate, that is mechanically and/or electrically controlled to move into position such that a magnetic field can be applied to magnetic particles in the enclosure. In one example where the sealed enclosure is a sealed cylindrical chamber comprising an inner wall and an outer wall, the magnetic field source is a cylindrical magnet that is movable into and out of a cavity or recess formed by the inner wall of the chamber. In another example where the sealed enclosure is a sealed cylindrical chamber, the magnetic field source comprises a recess and is disposed to receive the sealed cylindrical chamber into and out of the recess.

The magnetic field source may be a single construction or it may be assembled from multiple pieces. In one example, the pieces of the magnetic field source may be arranged according to the disclosure of U.S. Pat. No. 5,705,064, the relevant disclosure of which is incorporated herein by reference. Briefly, a magnetic particle separator is made from a permanent magnet structure that has a plurality of segments combined to form a cylinder. Each of the plurality of segments has a magnetic remanence and direction that varies so as to form a transverse magnetic field gradient within the bore of the cylinder. Such an arrangement permits the generation of a magnetic field as close to constant as possible.

In one example, the enclosure is a sealed cylindrical chamber that is formed by an inner wall and an outer wall and sealed at the top and bottom by top and bottom walls. A cylindrical cavity, recess or hollow area is in the center of the apparatus and is formed by the inner wall. The volume of the sealed cylindrical chamber may vary widely depending on the amount of the magnetic particle-containing fluid to be processed. For example, for small batches of fluid on the order of about 1 L to about 5 L, the volume of the sealed chamber may be about 0.01 L to about 0.5 L. For medium size batches of fluid on the order of about 5 L to about 20 L, the volume of the sealed chamber may be about 0.05 L to about 2 L. For large batches of fluid on the order of about 20 L to about 500 L, the volume of the sealed chamber may be about 0.2 L to about 5 L.

The sealed cylindrical chamber comprises an inlet into the chamber and an outlet from the chamber. The configuration of the cylindrical chamber and the disposition of the inlet and the outlet to the cylindrical chamber and to one another, in conjunction with the flow rate of introduction of fluid into the cylindrical chamber, results in spiral flow of a fluid through the chamber. In some examples the inlet and the outlet are positioned near the top and bottom walls of the chamber. As mentioned above, depending on the nature of the sealed enclosure, the inside diameter of the inlet may be a factor in achieving spiral flow within the sealed enclosure.

In some examples, the inlet and the outlet are positioned within about 5% of the top and bottom walls, respectively, based on the length of the cylindrical chamber.

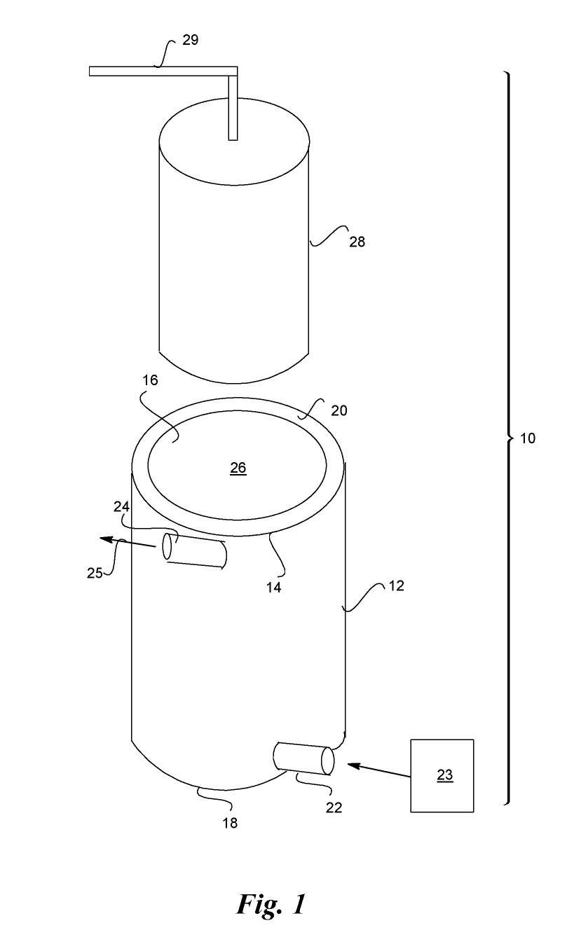

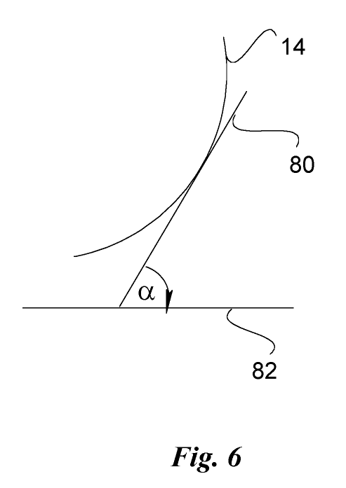

In some examples, the inlet and the outlet are each separately disposed to the outer wall of the cylindrical chamber at a tangential angle of about 0° to about 60°, or about 0° to about 45°, or about 0° to about 30°, or about 5° to about 60°, or about 10° to about 60°, for example. The tangential angle is depicted in FIG. 6 where tangential angle α is formed by line 80 that tangentially intersects outer wall 14 of cylindrical chamber 12 of FIG. 1 and intersects axis 82.

In some examples each of the inlet and the outlet is at an angle of about 0° to about 20° with respect to a circumferential plane of the cylindrical chamber that is parallel to one or both of the top or bottom walls of the cylindrical chamber.

In an example, the flow rate that is sufficient to achieve spiral flow of fluid within the chamber is low enough to be laminar.

Examples of apparatus and methods of using such apparatus to process magnetic particles in accordance with the principles described herein are discussed herein by way of illustration and not limitation.

An example of an apparatus in accordance with the principles described is herein is set forth in FIG. 1 by way of illustration and not limitation. Referring to FIG. 1, apparatus 10 comprises a cylindrical chamber 12 formed by outer wall 14 and inner wall 16 and sealed by top wall 20 and bottom wall 18. Cylindrical hollow cavity 26 is formed in the center of cylindrical chamber 12 by inner wall 16. Apparatus 10 further comprises inlet 22 and outlet 24, which provide access for a fluid into and out of cylindrical chamber 12. Fluid flow initiator 23 is fluidically associated with apparatus 10 at inlet 22. Apparatus 10 further includes magnet 28 that is disposed to cylindrical chamber 12 so that magnet 28 may be intermittently introduced into cavity 26 of cylindrical chamber 12. Magnet 28 is attached to support 29 that is movable using a suitable mechanism (not shown) for moving the support.

Fluid containing magnetic particles may be processed using apparatus 10 by introducing a fluid containing the magnetic particles into inlet 22 of cylindrical chamber 12 by means of fluid flow initiator 23. The orientation of inlet 22 and outlet 24 and the flow rate of the fluid are sufficient to result in the fluid exhibiting a spiral flow towards outlet 24 in direction 25. Fluid exiting chamber 12 through outlet 24 is collected in a suitable vessel or container, which may be changed depending on whether fluid free from magnetic particles is being collected or fluid containing magnetic particles is being collected in accordance with the principles described herein. Whether exiting fluid is free from or contains magnetic particles depends on the intermittent application of a magnetic field by movement of magnet 28 by means of mechanically driven support 29 into and out of recess 26 or cylindrical chamber 12. When magnet 28 is in position within recess 26, a magnetic field is applied to the fluid in cylindrical chamber 12 to adhere the magnetic particles to inner wall 16 within cylindrical chamber 12. Spiral flow of the fluid assists in keeping the magnetic particles suspended in the fluid during flow and assists in mixing of the magnetic particles with a wash buffer following application of the magnetic field. Processed magnetic particles that exit cylindrical chamber 12 are collected and used in applications such as those described above. The wash buffer may be selected from any suitable buffer solution such as those described above for the fluid containing the magnetic particles.

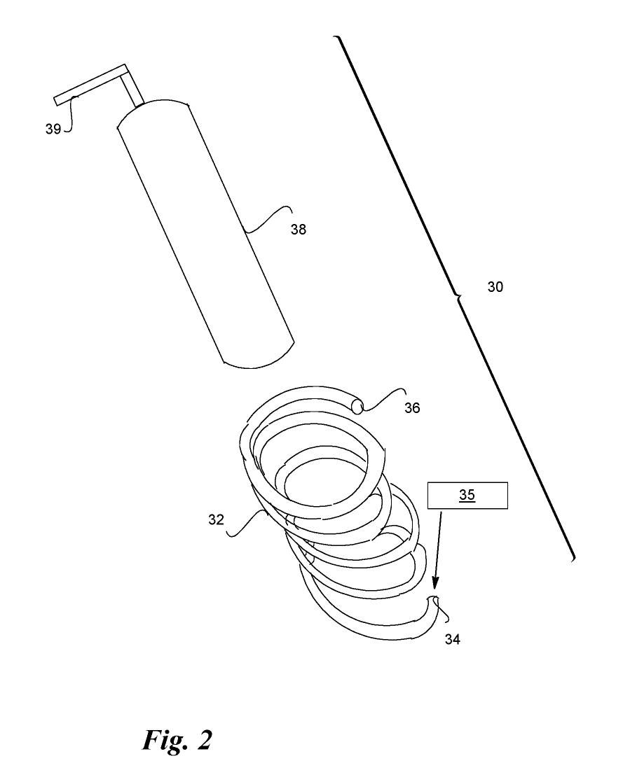

Another example, by way of illustration and not limitation, of an enclosure in accordance with the principles described herein is depicted in FIG. 2. Referring to FIG. 2, apparatus 30 comprises a spiral chamber 32. A hollow cavity is present through the center of the spiral chamber. Apparatus 30 further comprises inlet 34 and outlet 36, which provide access for a fluid into and out of spiral chamber 32. Fluid flow initiator 35 is fluidically associated with apparatus 30 at inlet 34. Apparatus 30 further includes magnet 38 that is disposed to spiral chamber 32 so that magnet 38 may be intermittently introduced into the hollow cavity of spiral chamber 32. Magnet 38 is attached to support 39 that is movable using a suitable mechanism for moving the support (not shown).

Fluid containing magnetic particles may be processed using apparatus 30 by introducing a fluid containing the magnetic particles into inlet 34 of spiral chamber 32 by means of fluid flow initiator 35. Fluid entering spiral chamber 32 through inlet 34 exhibits a spiral flow by virtue of the configuration of spiral chamber 32. The flow rate of the fluid is sufficient to move fluid exhibiting a spiral flow towards outlet 36. Fluid exiting chamber 32 through outlet 36 is collected in a suitable vessel or container, which may be changed depending on whether fluid free from magnetic particles is being collected or fluid containing magnetic particles is being collected in accordance with the principles described herein. Whether exiting fluid is free from or contains magnetic particles depends on the intermittent application of a magnetic field by movement of magnet 38 by means of mechanically driven support 39 into and out of the cavity formed through the middle of spiral chamber 32. When magnet 38 is in position within the cavity, a magnetic field is applied to the fluid in spiral chamber 32 to adhere the magnetic particles to the inner wall of spiral chamber 32. Spiral flow of the fluid assists in keeping the magnetic particles suspended in the fluid during flow and assists in mixing of the magnetic particles with a wash buffer following application of the magnetic field. Processed magnetic particles that exit spiral chamber 32 are collected and used in applications such as those described above.

In an alternative approach referring to FIG. 2, fluid may be introduced into outlet 36 and allowed to flow by pumping or suctioning or by gravity through spiral chamber 32 and exit through inlet 34.

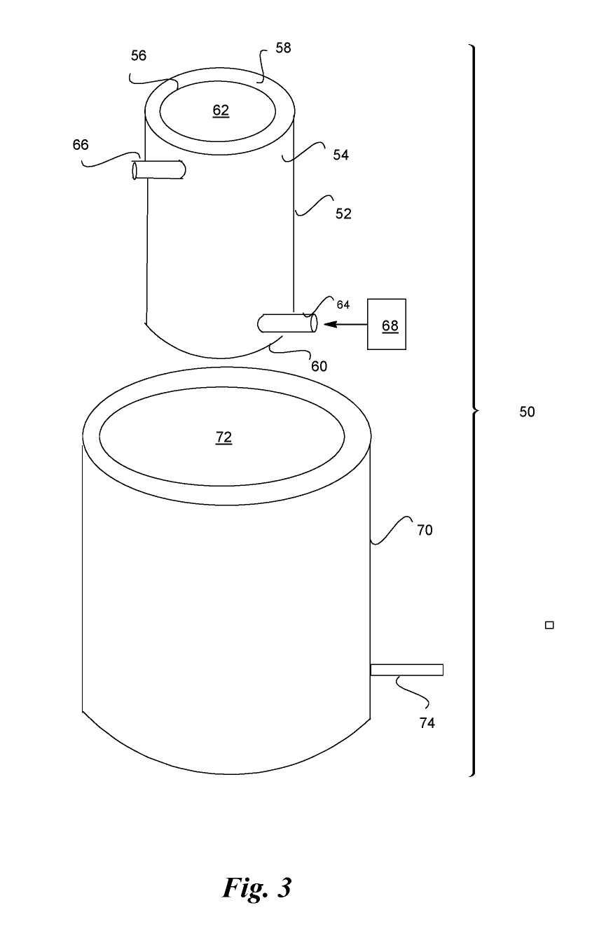

Another example of an apparatus in accordance with the principles described is herein is set forth in FIG. 3 by way of illustration and not limitation. Referring to FIG. 3, apparatus 50 comprises a cylindrical chamber 52 formed by outer wall 54 and inner wall 56 and sealed by top wall 58 and bottom wall 60. Cylindrical hollow cavity 62 is formed by inner wall 56. Apparatus 50 further comprises inlet 64 and outlet 66, which provide access for a fluid into and out of cylindrical chamber 52. Fluid flow initiator 68 is fluidically associated with apparatus 50 at inlet 64. Apparatus 50 further includes magnet 70 that has inner recess 72, the diameter of which is sufficient to allow cylindrical chamber 52 to move into recess 72. Magnet 70 and cylindrical chamber 52 are disposed to one another so that cylindrical chamber 52 may be intermittently introduced into recess 72 of magnet 70 by movement of magnet 70 or cylindrical chamber 52 or both. Magnet 70 is attached to support 74 that is movable using a suitable mechanism (not shown) for moving support 74.

In some examples, apparatus in accordance with the principles described herein comprise an array of two or more apparatus described above that are fluidically associated with one another in parallel or in series or a combination of both. An array of apparatus allows for an increase in processing capacity of fluid containing magnetic particles. The apparatus in the array can share a single magnetic field source or one or more of the apparatus in the array can use a separate magnetic field source. The number of apparatus in an array is dependent on one or more of the volume of fluid to be processed, the nature of the fluid, the nature of the magnetic particles, the nature of the processing, and the particle concentration, for example. In some examples, each of the apparatus of an array may be the same or may be different. When the apparatus of an array are different, they may differ in one or more of size and function such as, but not limited to, flow rate, strength of magnetic field applied, and time of retention of the magnetic particles during application of the magnetic field, for example. In this manner an increase in retaining efficiency of the magnetic particles during processing of magnetic particles in accordance with the principles described herein may be achieved. The phrase “increase in retaining efficiency” means that the fraction of the particles passing through the device becomes smaller and fraction of the particles retained by the device becomes larger.

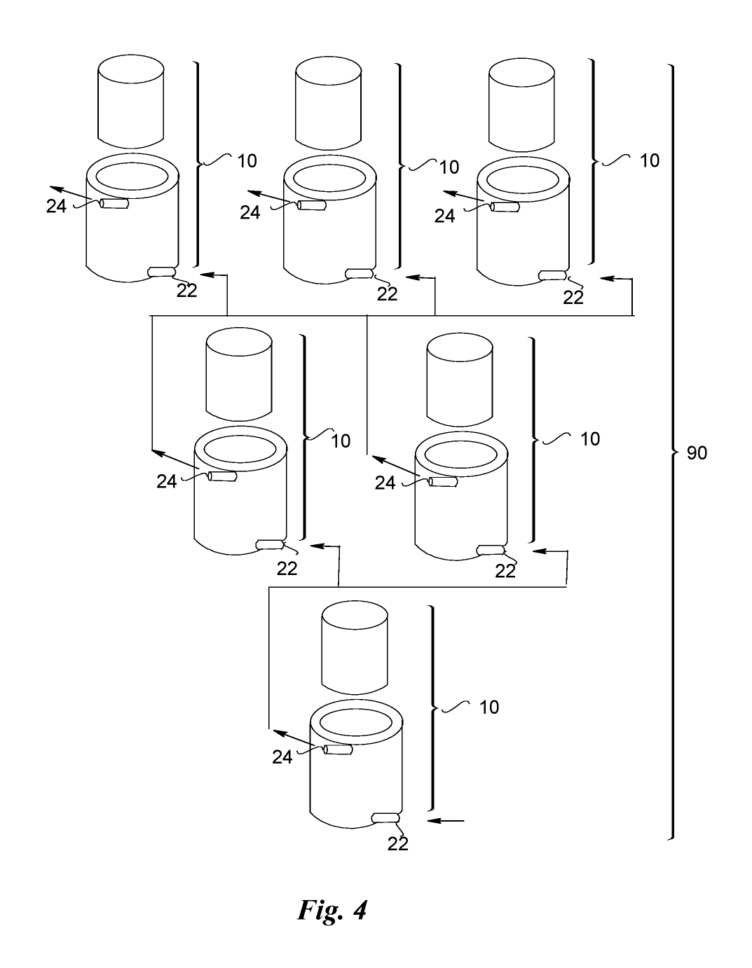

An example of an array of apparatus in accordance with the principles described herein is depicted in FIG. 4. In array 90 of FIG. 4, a number of apparatus 10 are shown fluidically associated with one another both in parallel and in series. The phrase “connected in parallel” means that a single apparatus is fluidically associated to at least two other apparatus of an array. The phrase “connected in series” means that a single apparatus is fluidically connected to another apparatus of an array, which in turn is fluidically associated to another apparatus of the array.

Array 90 illustrates a three stage arrangement of apparatus where the first stage consists of a single apparatus, a second stage consists of two apparatus connected in parallel to each other, and the third stage consists of three apparatus. All stages process the same flow of fluid containing magnetic particles. In the second stage, the magnetic particles have a residence time and a smaller shear force than that of the first stage. Apparatus in the third stage see only one-third of the fluid flow thereby achieving a reduction in shear force and an increase in residence time. In array 90, the first stage captures those magnetic particles that are strongly retained during application of a magnetic field; the second stage captures less strongly retained magnetic particles during application of a magnetic field; and the third stage captures slow-moving small and/or weakly retained magnetic particles during application of a magnetic field.

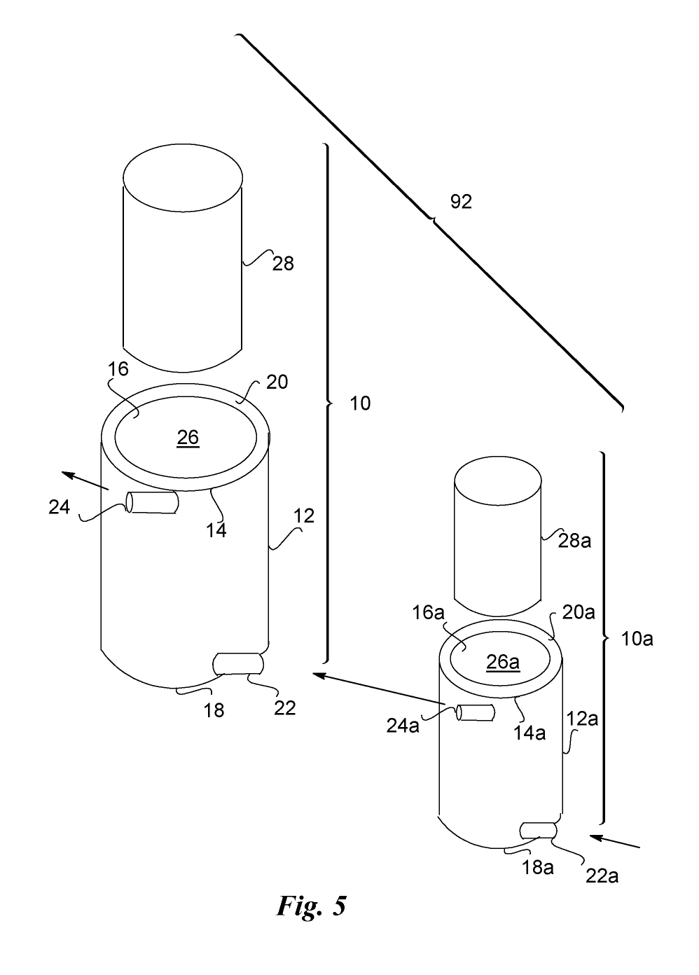

Another example of an array of apparatus in accordance with the principles described herein is depicted in FIG. 5. In array 92 of FIG. 5, apparatus 10 and apparatus 10a are shown fluidically connected in series where apparatus 10a is smaller in size than apparatus 10. As may be appreciated, additional apparatus 10 may be part of the array of FIG. 5 where each of apparatus 10 may be the same or different and the apparatus may be fluidically associated with one another in series or in parallel or a combination of both. In array 92, linear flow rate is smaller in apparatus 10 of larger size. Thus, magnetic particles in the larger size apparatus 10 exhibit longer residence time for moving across cylindrical chamber 12, and shear forces generated by flowing fluid though cylindrical chamber 12 are smaller.

In another example, by way of illustration and not limitation, two cylindrical chambers with different diameters can be used in conjunction with a single cylindrically shaped magnet The smaller of the two cylindrical chambers fits inside the cavity in the cylindrical magnet and the larger of the two cylindrical chambers goes around the outside of the cylindrical magnet. The two cylindrical chambers are connected in series.

As mentioned above, a method for processing magnetic particles comprises subjecting a fluid containing the magnetic particles to a spiral fluid flow and intermittently applying a magnetic field to the fluid to retain the magnetic particles while allowing fluid to flow away from the retained magnetic particles. Application of the magnetic field retains the magnetic particles at a certain location while allowing fluid to flow away from the magnetic particles. Removal of the magnetic field allows the particles to be released back into fluid other than the fluid in which the magnetic particles were originally contained. Spiral flow facilitates re-suspension of the magnetic particles in the fluid.

The phrase “intermittently applying” means that the magnetic field is not continuously applied for the duration of the processing of the magnetic particles. The timing of and the duration of the application of the magnetic field is dependent on one or more of the nature of the magnetic particles, the nature of the fluid, the strength of the magnetic field, and the volume of the fluid that is processed, for example. In some examples, the duration of application of the magnetic field to the fluid containing the magnetic particles (or the time of retention of the magnetic particles to a wall of an apparatus in accordance with the principles described herein) is about 1 minute to about 1 hour and the magnetic field is applied at intervals of about 1 minute to about 1 hour.

Prior to application of the magnetic field to the fluid, one or both of the ionic strength and the pH of the fluid may be adjusted to promote aggregation of the magnetic particles. The ionic strength and/or the pH of the fluid may be adjusted to that which is sufficient to achieve the desired promotion of aggregation of the magnetic particles. The ionic strength and the pH of the fluid are dependent on one or more of the nature of the dissolved substances, the concentration of dissolved substances, the temperature, and the nature of the fluid, for example. In some examples, to promote aggregation of the magnetic particles, the ionic strength of the fluid is adjusted to a level sufficient to promote such aggregation. Adjustment of the ionic strength to promote aggregation may be realized by dissolving inorganic substances, dissolving organic substances, or adding water miscible liquids, for example. In some examples, to promote aggregation of the magnetic particles, the pH of the fluid is adjusted to within the range of about 4 to about 10, or about 5 to about 10, or about 5 to about 9, or about 4 to about 9, for example. Adjustment of the pH to promote aggregation of the magnetic particles may be realized by addition to the fluid of a suitable acid or base or buffer such as one or more of the buffers mentioned above. The temperature of the fluid during processing is about 4° C. to about 50° C., depending on the nature of the fluid and the nature of the magnetic particles, for example.

Following aggregation of the magnetic particles and prior to or during removal of the application of the magnetic field, the fluid may be treated to promote deaggregation of the magnetic particles. Deaggregation may be promoted by adjusting one or more of the ionic strength and the pH of the fluid or by subjecting the magnetic particles to a gas-liquid mixture. In some examples, to promote deaggregation of the magnetic particles, the ionic strength of the fluid is adjusted to a level sufficient to promote such deaggregation. Adjustment of the ionic strength to promote deaggregation may be realized by replace solvent to another one with lower ionic content, neutralizing extreme pH, desalting, diluting with deionized water, for example. In some examples, to promote deaggregation of the magnetic particles, the pH of the fluid is adjusted to diverge as far as possible from the isoelectric point. Adjustment of the pH to promote deaggregation of the magnetic particles may be realized by addition to the fluid of a suitable acid or base or buffer such as one or more of the buffers mentioned above. In one approach, the pH of the fluid is adjusted to a value different from the isoelectric point for resuspension of the magnetic particles. The temperature of the fluid during processing is about 4° C. to about 50° C., depending on the nature of the fluid, the nature of the magnetic particles, and the nature of any organic substances present on the surface of a particle, for example.

The magnetic particles in the fluid may be subjected to a gas-liquid mixture by introducing into the fluid a gas just prior to or during removal of the application of the magnetic field to the fluid. The gas may be, but is not limited to, air, nitrogen and helium, for example, or a mixture of two or more of the above. The type and amount of gas introduced into the fluid is dependent on one or more of the nature of the fluid and the nature of the magnetic particles, for example. Introduction of the gas into the fluid may be achieved, for example, by using a pump or connecting to a vessel with compressed gas.

General Description of Assays in which the Magnetic Particles May Be Utilized

The following discussion is by way of illustration and not limitation. The present compositions may be employed in any assay that involves magnetic separation of one or more of any of the assay components or products. Since the assays involve one or more separation steps, they are referred to as heterogeneous assays. The assays can be competitive or non-competitive.

An assay is a method of determining in a sample one or both of the presence and the amount of an analyte in the sample. The analyte is a substance of interest or the compound or composition to be detected and/or quantitated. Analytes include, for example, drugs, metabolites, pesticides and pollutants. Representative analytes, by way of illustration and not limitation, include alkaloids, steroids, lactams, aminoalkylbenzenes, benzheterocyclics, purines, drugs derived from marijuana, hormones, polypeptides which includes proteins, immunosuppressants, vitamins, prostaglandins, tricyclic antidepressants, anti-neoplastics, nucleosides and nucleotides including polynucleosides and polynucleotides, miscellaneous individual drugs which include methadone, meprobamate, serotonin, meperidine, lidocaine, procainamide, acetylprocainamide, propranolol, griseofulvin, valproic acid, butyrophenones, antihistamines, chloramphenicol, anticholinergic drugs, and metabolites and derivatives of all of the above. Also included are metabolites related to disease states, aminoglycosides, such as gentamicin, kanamicin, tobramycin, and amikacin, and pesticides such as, for example, polyhalogenated biphenyls, phosphate esters, thiophosphates, carbamates and polyhalogenated sulfenamides and their metabolites and derivatives. The term “analyte” also includes combinations of two or more of polypeptides and proteins, polysaccharides and nucleic acids. Such combinations include, for example, components of bacteria, viruses, chromosomes, genes, mitochondria, nuclei and cell membranes. Protein analytes include, for example, immunoglobulins, cytokines, enzymes, hormones, cancer antigens, nutritional markers and tissue specific antigens. Such proteins include, by way of illustration and not limitation, protamines, histones, albumins, globulins, scleroproteins, phosphoproteins, mucoproteins, chromoproteins, lipoproteins, nucleoproteins, glycoproteins, T-cell receptors, proteoglycans, HLA, unclassified proteins, e.g., somatotropin, prolactin, insulin, pepsin, proteins found in human plasma, blood clotting factors, protein hormones such as, e.g., follicle-stimulating hormone, luteinizing hormone, luteotropin, prolactin, chorionic gonadotropin, tissue hormones, cytokines, cancer antigens such as, e.g., PSA, CEA, α-fetoprotein, acid phosphatase, CA19.9, CA15.3 and CA125, tissue specific antigens, such as, e.g., alkaline phosphatase, myoglobin, CPK-MB and calcitonin, and peptide hormones. Other polymeric materials of interest are mucopolysaccharides and polysaccharides. As indicated above, the term analyte further includes oligonucleotide and polynucleotide analytes such as m-RNA, r-RNA, t-RNA, DNA and DNA-RNA duplexes, for example.

The sample to be tested may be non-biological or biological. “Non-biological samples” are those that do not relate to a biological material and include, for example, soil samples, water samples and mineral samples. The phrase “biological sample” refers to any biological material, such as, for example, body fluid and body tissue, which is obtained from the body of a mammal including humans, birds, reptiles, and other vertebrates. Body fluids include, for example, whole-blood, plasma, serum, interstitial fluid, sweat, saliva, urine, semen, blister fluid, inflammatory exudates, stool, sputum, cerebral spinal fluid, tears, mucus, lymphatic fluid, vaginal mucus, and the like. The biological tissue includes, but is not limited to, excised tissue from an organ or other body part of a host, e.g., tissue biopsies; hair and skin; for example.

In a method of determining an analyte in a sample, a combination is provided in a medium. The combination comprises the sample, an sps member that is bound to an sbp member that binds to the analyte or binds to an analyte analog, and a composition comprising magnetic particles that comprises an sbp member, which binds to the analyte or binds to an sbp member that binds to the analyte to form a complex related to the presence of the analyte, and a coating of a synthetic copolymer as described above.

An analyte analog is a modified analyte or an organic radical that can compete with an analyte for a receptor, the modification providing means to join an analyte analog to another molecule. The analyte analog differs from the analyte by at least replacement of a hydrogen with a bond that links the analyte analog to another moiety. The analyte analog can bind to a receptor in a manner similar to the analyte. The analog could be, for example, an antibody directed against the idiotype of an antibody to the analyte or an analyte that has been modified to incorporate an sps member.

The sample can be prepared in any convenient medium. For example, the sample may be prepared in an assay medium, which is discussed more fully hereinbelow. In some instances a pretreatment may be applied to the sample such as, for example, to lyse blood cells or to release an analyte from endogenous binding substances in the sample. Such pretreatment is usually performed in a medium that does not interfere subsequently with an assay. An aqueous medium is preferred for the pretreatment where the aqueous medium may be solely water or solely an organic solvent or mixtures thereof.

An assay medium, which in some embodiments is an aqueous buffered medium at a moderate pH, is generally one that provides optimum assay sensitivity. The aqueous medium may be solely water or may include from 0.1 to about 40 volume percent of a cosolvent such as, for example, a water miscible organic solvent, e.g., an alcohol, an ether or an amide. The pH for the medium will usually be in the range of about 4 to about 11, or in the range of about 5 to about 10, or in the range of about 6.5 to about 9.5, for example. The pH utilized is often the result of a compromise between optimum binding of the binding members of any specific binding pairs and the pH optimum for other reagents of the assay such as members of the signal producing system, for example. Various buffers may be used to achieve the desired pH and maintain the pH during the determination. Illustrative buffers include borate, phosphate, carbonate, tris, barbital, PIPES, HEPES, MES, ACES, MOPS, BICINE, and the like. The particular buffer employed is not critical, but in an individual assay one or another buffer may be preferred.

Various ancillary materials may be employed in the assay methods. For example, in addition to buffers, the medium may comprise stabilizers for the medium and for the reagents employed. In some embodiments, in addition to these additives, the medium may include proteins such as, e.g., albumins; organic solvents such as, e.g., formamide; quaternary ammonium salts; polyanions such as, e.g., dextran sulfate; binding enhancers, e.g., polyalkylene glycols; polysaccharides such as, e.g., dextran, trehalose, or the like. The medium may also comprise agents for preventing the formation of blood clots. Such agents are well known in the art and include, for example, EDTA, EGTA, citrate and heparin. The medium may also comprise one or more preservatives as are known in the art such as, for example, sodium azide, neomycin sulfate, PROCLIN® 300 and Streptomycin. Any of the above materials, if employed, is present in a concentration or amount sufficient to achieve the desired effect or function.

As mentioned above, for an assay for an analyte the magnetic particles may comprise an sbp member, which binds specifically to the analyte or binds specifically to an sbp member that binds specifically to the analyte, to form a complex related to the presence of the analyte. The nature of the sbp member on the magnetic particles depends on one or more of the nature of the analyte, the nature of the assay employed, and conditions under which an assay is performed, for example. In an example, the sbp member on the magnetic particles may be an antibody that binds specifically to the analyte. In another example, the sbp member on the magnetic particles may be an analyte analog that binds to an antibody for the analyte. In another example, the sbp member on the magnetic particles may be an antibody that binds specifically to another antibody that binds specifically to the analyte. In another example, the sbp member on the magnetic particles may be a member of an sbp that is specific for a moiety other than an analyte analog or an antibody for the analyte, such as, a binding partner for a small molecule, where the complementary sbp member is a binding partner for the small molecule such as, but not limited to, streptavidin (for biotin), avidin (for biotin), and folate binding protein (for folate), for example.

In addition to the above, the combination in the assay medium also comprises an sps member that is bound to an sbp member that specifically binds to the analyte or further comprises an sps member that is bound to an analyte analog. The nature of the molecule to which the sps member is bound depends on one or more of the nature of the analyte, the nature of the assay employed, and the nature of the sbp member on the magnetic particles, for example. In an example, the sps member is bound to an antibody that specifically binds to the analyte. In another example, the sps member is bound to an analyte analog.

In the assay methods in accordance with the principles described herein, the above combination is subjected to conditions for forming a complex. Such conditions may include one or more incubation periods that may be applied to the medium at one or more intervals including any intervals between additions of various reagents employed in an assay including those mentioned above, some or all of which may be in the initial combination. The medium is usually incubated at a temperature and for a time sufficient for binding of various components of the reagents and binding between complementary sbp members such as, for example, an analyte and a complementary sbp member or first and second sbp members to occur. Moderate temperatures are normally employed for carrying out the method and usually constant temperature, preferably, room temperature, during the period of the measurement. In some embodiments incubation temperatures range from about 5° to about 99° C., or from about 15° C. to about 70° C., or from about 20° C. to about 45° C., for example. The time period for the incubation is about 0.2 seconds to about 24 hours, or about 1 second to about 6 hours, or about 2 seconds to about 1 hour, or about 1 to about 15 minutes, for example. The time period depends on the temperature of the medium and the rate of binding of the various reagents, which is determined by one or more of the association rate constant, the concentration, the binding constant and dissociation rate constant, for example.

Following the above incubation periods, if any, the sps member is activated and the amount of the complex is detected. In some examples, the magnetic particles to which the complex is bound is separated from the assay medium and optionally washed prior to activation of the sps member on the magnetic particles. In some examples, the assay medium, from which the magnetic particles is separated, is examined by activating complex not bound to the magnetic particles. The amount of the complex is related to one or both of the presence and the amount of analyte in the sample. The detection of the complex is dependent on one or more of the nature of the assay being performed, the nature of the sps members, and the nature of the sbp members, for example.

As mentioned above, the composition also comprises an sps member. The nature of the sps member depends on the type of assay in which embodiments of the present compositions may be employed. The sps member may be a label, which is part of a signal producing system. The nature of the label is dependent on the particular assay format as discussed above. A signal producing system may include one or more components, at least one component being a detectable label, which generates a detectable signal that relates to one or both of the amount of bound and unbound label, i.e. the amount of label bound or not bound to analyte being detected or to an agent that reflects the amount of the analyte to be detected. The label is any molecule that produces or can be induced to produce a signal, and may be, but is not limited to, a fluorescer, a radiolabel, an enzyme, a chemiluminescent compound, or a sensitizer (including photosensitizers), for example . Thus, the signal is detected and/or measured by detecting enzyme activity, luminescence, light absorbance or radioactivity, for example, depending on the nature of the label.

Suitable labels include, by way of illustration and not limitation, chemiluminescent compounds such as acridinium esters (including acridinium esters comprising one or more substituents such as, for example, luminol, and isoluminol, for example; enzymes such as alkaline phosphatase, glucose-6-phosphate dehydrogenase (“G6PDH”) and horseradish peroxidase; ribozyme; a substrate for a replicase such as QB replicase; promoters; dyes; fluorescers, such as fluorescein, isothiocyanate, rhodamine compounds, phycoerythrin, phycocyanin, allophycocyanin, o-phthaldehyde, and fluorescamine; complexes such as those prepared from CdSe and ZnS present in semiconductor nanocrystals known as Quantum dots; sensitizers including photosensitizers; coenzymes; enzyme substrates; radiolabels such as ¹²⁵I, ¹³¹I, ¹⁴C, ³H, ⁵⁷Co and ⁷⁵Se; for example.

The label can directly produce a signal and, therefore, additional components are not required to produce a signal. Numerous organic molecules, for example fluorescers, are able to absorb ultraviolet and visible light, where the light absorption transfers energy to these molecules and elevates them to an excited energy state. This absorbed energy is then dissipated by emission of light at a second wavelength. Other labels that directly produce a signal include radioactive isotopes and dyes.

Alternately, the label may need other components to produce a signal, and the signal producing system would then include all the components required to produce a measurable signal. Such other components may include, for example, substrates, coenzymes, enhancers, additional enzymes, substances that react with enzymic products, catalysts, activators, cofactors, inhibitors, scavengers, metal ions, oxidizers, acids, bases, surfactants, and a specific binding substance required for binding of signal generating substances.

The concentration of the analyte that may be assayed generally varies from about 10⁻⁵ to about 10⁻¹⁷ M, or from about 10⁻⁶ to about 10⁻¹⁴ M. Considerations, such as whether the assay is qualitative, semi-quantitative or quantitative (relative to the amount of the analyte present in the sample), the particular detection technique and the expected concentration of the analyte normally determine the concentrations of the various reagents.

The concentrations of the various reagents in the assay medium will generally be determined by the concentration range of interest of the analyte and the nature of the assay, for example. However, the final concentration of each of the reagents is normally determined empirically to optimize the sensitivity of the assay over the range. That is, a variation in concentration of analyte that is of significance should provide an accurately measurable signal difference. Considerations such as the nature of the signal producing system and the nature of the analytes, for example, determine the concentrations of the various reagents.

As mentioned above, the sample and reagents are provided in combination in the medium. While the order of addition to the medium may be varied, there will be certain preferences for some embodiments of the assay formats described herein. The simplest order of addition is to add all the materials simultaneously and determine the effect that the assay medium has on the signal as in a homogeneous assay or separate a composition in accordance with the principles described herein by application of a magnetic field and examine the composition for the presence and/or amount of signal as in a heterogeneous assay. Alternatively, each of the reagents, or groups of reagents, can be combined sequentially. In some embodiments, an incubation step may be involved subsequent to each addition as discussed above. In heterogeneous assays, washing steps may also be employed after one or more incubation steps.

One example of the use of magnetic particles is an acridinium ester label immunoassay using magnetic particles as a solid phase (“ADVIA” immunoassay). The assay may be carried out on a CENTAUR®, CENTAUR® XP or CENTAUR® CP apparatus (Siemens Healthcare Diagnostics Inc., Newark DE) in accordance with the manufacturer's directions supplied therewith.

### Kits Comprising Reagents for Conducting Assays

Magnetic particles processed in accordance with the principles described herein may be present in a kit useful for conveniently performing an assay for the determination of an analyte. In some embodiments a kit comprises in packaged combination the magnetic particles. In some embodiments, depending on the nature of an assay, the kit also includes other reagents for performing the assay, the nature of which depend upon the particular assay format.

The reagents may each be in separate containers or various reagents can be combined in one or more containers depending on the cross-reactivity and stability of the reagents. The kit can further include other separately packaged reagents for conducting an assay such as additional sbp members, sps members and ancillary reagents, for example.

The relative amounts of the various reagents in the kits can be varied widely to provide for concentrations of the reagents that substantially optimize the reactions that need to occur during the present methods and further to optimize substantially the sensitivity of an assay. Under appropriate circumstances one or more of the reagents in the kit can be provided as a dry powder, usually lyophilized, including excipients, which on dissolution will provide for a reagent solution having the appropriate concentrations for performing a method or assay utilizing embodiments of the present compositions. The kit can further include a written description of a method as described above.

### Definitions

The following definitions are provided for terms and phrases not otherwise specifically defined above.

The phrase “at least” as used herein means that the number of specified items may be equal to or greater than the number recited.

The phrase “about” as used herein means that the number recited may differ by plus or minus 10%; for example, “about 5” means a range of 4.5 to 5.5.

The designations “first” and “second” are used solely for the purpose of differentiating between two or more items and are not meant to imply any sequence or order or importance to one item over another or any order of addition, for example.

The following examples further describe specific embodiments of the invention by way of illustration and not limitation and are intended to describe and not to limit the scope of the invention. Parts and percentages disclosed herein are by volume unless otherwise indicated.

All publications and patent applications cited in this specification are herein incorporated by reference as if each individual publication or patent application were specifically and individually indicated to be incorporated by reference.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims. Furthermore, the foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Many modifications and variations are possible in view of the above teachings. The embodiments were chosen and described in order to explain the principles of the invention and its practical applications and to thereby enable others skilled in the art to utilize the invention.

What is claimed is:

1. An apparatus for processing magnetic particles, the apparatus comprising:
a sealed enclosure comprising an inlet into the enclosure and an outlet from the enclosure, wherein the configuration of the enclosure and of the inlet and the outlet are such that fluid containing the magnetic particles that is introduced into the enclosure through the inlet exhibits a spiral flow towards the outlet, and
a magnetic field source disposed to the enclosure to intermittently apply a magnetic force to the fluid.

2. The apparatus according to claim 1, wherein the sealed enclosure is a sealed cylindrical chamber comprising an inner wall and an outer wall and wherein the inlet and the outlet are each separately disposed to the outer wall at a tangential angle of about 0° to about 60°.

3. The apparatus according to claim 2, wherein each of the inlet and the outlet is at an angle of about 0° to about 20° with respect to a circumferential plane of the cylindrical chamber.

4. The apparatus according to claim 1, wherein the sealed enclosure is a spiral enclosure.

5. The apparatus according to claim 1 further comprising a fluid flow initiator fluidically associated with the enclosure.

6. The apparatus according to claim 5, wherein the fluid flow initiator is a pump, a suction device, gravity, or a compressed gas.

7. The apparatus according to claim 1, wherein one or both of the magnetic field source and the sealed enclosure are movably disposed to one another.

8. The apparatus according to claim 7, wherein the sealed enclosure is a sealed cylindrical chamber comprising an inner wall and an outer wall and wherein the magnetic field source is a cylindrical magnet that is movable into and out of a recess formed by the inner wall of the chamber or wherein the magnetic field source comprises a recess and is disposed to receive the sealed cylindrical chamber.

9. The apparatus according to claim 1, wherein the magnetic field source comprises one or more permanent magnets.

10. An apparatus for processing magnetic particles, the apparatus comprising two or more of the apparatus of claim 1, wherein the apparatus of claim 1 are fluidically connected in parallel or in series and wherein each of the apparatus of claim 1 may be the same or may be different.

11. A method for processing magnetic particles, the method comprising:
introducing a fluid containing the magnetic particles into an inlet of a sealed enclosure comprising an inlet into the enclosure and an outlet from the enclosure, wherein the inlet and the outlet are disposed to the enclosure such that fluid introduced into the enclosure through the inlet at a sufficient flow rate exhibits a spiral flow towards the outlet, and
intermittently activating a magnetic field source to apply a magnetic force to the fluid in the sealed enclosure to adhere the magnetic particles to an inner wall of the sealed enclosure.

12. The method according to claim 11, wherein the sealed enclosure is a sealed cylindrical chamber comprising an inner wall and an outer wall and wherein the inlet and the outlet are each separately disposed to the outer wall at a tangential angle of about 0° to about 60°.

13. The method according to claim 12, wherein each of the inlet and the outlet is at an angle of about 0° to about 20° with respect to a circumferential plane of the cylindrical chamber.

14. The method according to claim 11, wherein the sealed enclosure is a spiral enclosure.

15. The method according to claim 11, wherein fluid is introduced into the chamber by means of a fluid flow initiator fluidically associated with the chamber and fluid is caused to flow through the sealed enclosure by means of the fluid flow initiator.

16. The method according to claim 15, wherein the fluid flow initiator is a pump, a suction device, gravity, or compressed gas.

17. The method according to claim 11, wherein the magnetic field source and the sealed enclosure are movably disposed to one another.

18. A method for processing magnetic particles, the method comprising:
subjecting a fluid containing the magnetic particles to a spiral fluid flow and
intermittently applying a magnetic force to the fluid to retain the magnetic particles while allowing fluid to flow away from the retained magnetic particles.

19. The method according to claim 18, wherein the ionic strength or the pH of the fluid is adjusted to promote aggregation of the magnetic particles prior to application of the magnetic force to the fluid.

20. The method according to claim 19, wherein deaggregation of the magnetic particles is promoted by adjusting the ionic strength or the pH of the fluid or by subjecting the magnetic particles to a gas-liquid mixture.
